(19) United States
(12) Patent Application Publication
(10) Pub. No.: US 2012/0104048 A1
(43) Pub. Date: May 3, 2012

(54) FOAM DISPENSING DEVICE

(75) Inventor: Sen-Li TSENG, Taichung City (TW)

(73) Assignee: HSIH TUNG TOOLING CO.,LTD., Taichung City (TW)

(21) Appl. No.: 12/912,746

(22) Filed: Oct. 27, 2010

(51) Int. Cl. B67D 7/76

(52) U.S. Cl. 222/190

(57) ABSTRACT

A foam dispensing device includes an outer tube connecting with a liquid container. A lower tube and an upper tube are partially received in the outer tube. The lower tube has a guide chamber defined therein which has a second inlet defined therein. A liquid piston is connected with the lower tube for selectively sealing the second inlet. A spring is compressibly received in the outer tube and abuts against the lower tube. The upper tube sleeves on the lower tube and has a mixing chamber defined therein for communicating with the guide chamber. An air piston movably sleeves on the upper tube and has at least one air hole defined therein for guiding air into the outer tube. A dispensing head is connected with the upper tube and has a nozzle formed thereon.

### BACKGROUND OF THE INVENTION

1. Field of the Invention

The present invention relates to a foam dispensing device, and more particularly to a device adapted to connect with a liquid container and being able to enhance mixing of air and liquid to generate foaming.

2. Description of Related Art

A conventional dispensing container comprises a containing body and a dispensing pump which has a nozzle disposed thereon, and cover. The dispensing pump includes a tubular device and a piston device received in the tubular device. The tubular device includes a relatively thick tube and a relatively thin tube which has a guiding tube disposed on a bottom end thereof. The piston device has a piston slidably connected with the relatively thin tube, a raising valve engaged with the piston, a piston-guiding member buckled with a top of the piston, an air piston, an air valve, and a shaft. The air piston has an inner sleeve connected with an outer periphery of the air-guiding member, an upper portion having at least one air hole defined therein, and a slidable sleeve slidably received in the relatively thick tube and forming an air chamber in the relatively thick tube. The air valve is engaged with an outer periphery of the inner sleeve and seals/unseals the at least one air hole of the air piston. The shaft is connected with an upper section of the piston-guiding member. An air-liquid chamber is formed in the upper section of the piston-guiding member and receives a ball valve. The nozzle is disposed on the shaft.

However, when air flows into the containing body via the at least one air hole of the air piston, the air valve of the conventional dispensing container is used to seal or unseal the air piston for controlling the control the amount of air which flows into the containing body. Therefore, the conventional dispensing container is a relatively complicated mechanical design, and it has a high cost of manufacturing the redundant air valve.

The present invention has arisen to mitigate and/or obviate the disadvantages of the conventional dispensing container.

### SUMMARY OF THE INVENTION

The main objective of the present invention is to provide an improved revolving screwdriver with ratchet structure.

To achieve the objective, the foam dispensing device includes an outer tube adapted to axially connect with a liquid container. The outer tube has a tubular member axially disposed therein and located at a bottom end thereof. The tubular member has a first inlet defined in a bottom end thereof and received in the liquid container, such that liquid in the liquid container is guided into the tubular member from the first inlet. A steel ball is movably received in the tubular member and located close to the first inlet for preventing a backflow of liquid in the tubular member. The outer tube has a ventilating hole laterally defined therein and extending therethrough for selectively communicating the outer tube with the liquid container.

A lower tube is axially and movably received in the outer tube. The lower tube has a bottom slidably received in a top end of the tubular member. The lower tube has a guide chamber defined therein. The bottom end of the lower tube has a second inlet laterally defined therein for selectively communicating the tubular member with the guide chamber. A liquid piston is connected with the bottom end of the lower tube for selectively sealing the second inlet. The lower tube has a lower flange annularly formed on an outer periphery thereof. The lower flange has a restraining portion annularly formed on an edge thereof and extending downwardly therefrom.

A spring is axially received in the outer tube. The spring is compressibly wound around the outer periphery of the lower tube and an outer periphery of the tubular member. The spring has one end abutting against an interior bottom surface of the outer tube. The spring has the other end abutting against the lower flange of the lower tube and restrained by the restraining portion of the lower tube for providing a resilient force to the lower tube.

An upper tube is axially received in the outer tube. The upper tube has a bottom end movably sleeving on a top end of the lower tube for simultaneously and axially moving with the lower tube relative to the outer tube. The upper tube has a mixing chamber defined therein and communicating with the guide chamber of the lower tube. An air gap is defined between an inner periphery of the bottom end of the upper tube and an outer periphery of the top end of the lower tube. The air gap extends between the upper tube and the lower tube to form a channel annularly located between the bottom end of the upper tube and a top of the lower flange for selectively communicating the outer tube with the mixing chamber and the guide chamber. The upper tube has an upper flange annularly formed on an outer periphery thereof.

An air piston is movably received in the outer tube and sleeves on the upper tube. The air piston is located between the upper flange and the lower flange for selectively sealing the air gap and the ventilating hole of the outer tube. The air piston has at least one air hole axially defined therein for guiding air into the outer tube.

A connecting cap is mounted on a top end of the outer tube and sleeves on the upper tube. The connecting cap is adapted to be located on a top of the liquid container. A ventilating space is defined between the outer periphery of the upper tube and an inner periphery of the connecting cap, such that air is able to flow into the outer tube via the ventilating space. A container cap sleeves on the connecting cap. The container cap has a third threaded portion annularly formed on an inner periphery thereof for adapting to be threadedly mounted on the top of the liquid container.

A dispensing head is connected with a top end of the upper tube for axially moving with the upper tube and the lower tube relative to the outer tube. The dispensing head has a nozzle formed thereon and communicating with the mixing chamber of the upper tube. The dispensing head has a grid member disposed therein and located between the mixing chamber and the nozzle for enhancing foaming. A connecting structure is formed between the connecting cap and the dispensing head. The connecting structure has a first threaded portion annularly formed on the inner periphery of the connecting cap and a second threaded portion annularly formed on a bottom of the dispensing head, such that the first threaded portion correspondingly engages with the second threaded portion.

When the dispensing head is pressed downwardly by a user, the upper and lower tubes are simultaneously moved downwardly with the dispensing head. The upper flange of the upper tube is moved to push the air piston downwardly and seals the at least one air hole of the air piston, such that the air piston unseals the air gap and the ventilating hole. Air in the outer tube is forced to flow into the mixing chamber of the upper tube via the air gap. Simultaneously, the spring is compressed and the liquid piston moves to unseal the second inlet by an axial movement of the lower tube. Liquid in the tubular member is forced to flow into the guide chamber of the lower tube via the second inlet and sequentially guided into the mixing chamber of the upper tube for mixing with air.

When the user releases the dispensing head, the spring provides the resilient force for pressing the lower tube upwardly. The liquid piston seals the second inlet by the axial movement of the lower tube. The upper tube and the dispensing head are simultaneously moved upwardly. The air piston is pushed upwardly by the lower flange of the lower tube, such that the air piston seals the air gap and the ventilating hole. The upper flange of the upper tube moves upwardly and unseals the at least one air hole.

In accordance with a second aspect of the present invention, the connecting structure has a first threaded portion annularly formed on an outer periphery of the connecting cap and a second threaded portion annularly formed on the bottom of the dispensing head, such that the first threaded portion correspondingly engages with the second threaded portion. The connecting cap has a first abutting portion annularly formed thereon and extending downwardly therefrom. The first abutting portion is received in the outer tube and correspondingly abutting against a top of the upper flange of the upper tube for restricting an axial movement of the upper tube. The connecting cap has a second abutting portion annularly formed thereon and extending downwardly therefrom. The second abutting portion is received in the outer tube and correspondingly abutting against the top of the air piston for restricting an axial movement of the air piston.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a preferred embodiment of a foam dispensing device in accordance with the present invention;

FIG. 2 is a perspective view of an air piston of the preferred embodiment of the foam dispensing device in accordance with the present invention;

FIG. 3 is a top plan view of the air piston of the preferred embodiment of the foam dispensing device in accordance with the present invention;

FIG. 4 is a cross-sectional plan view taken along the line IV-IV in FIG. 3;

FIG. 5 is an assembled view of the preferred embodiment of the foam dispensing device in accordance with the present invention as connecting with a liquid container;

FIG. 6 is a cross-sectional view of the preferred embodiment of the foam dispensing device in accordance with the present invention in a storage position;

FIG. 7 is a cross-sectional view of the preferred embodiment of the foam dispensing device in accordance with the present invention in an operation position;

FIGS. 8-9 are operational cross-sectional views of the preferred embodiment of the foam dispensing device in accordance with the present invention;

FIG. 10 is an assembled view of a second embodiment of the foam dispensing device in accordance with the present invention as connecting with the liquid container

FIG. 11 is a cross-sectional view of the second embodiment of the foam dispensing device in accordance with the present invention in the storage position; and

FIG. 12 is a cross-sectional view of the second embodiment of the foam dispensing device in accordance with the present invention in the operation position.

### DETAILED DESCRIPTION OF THE INVENTION

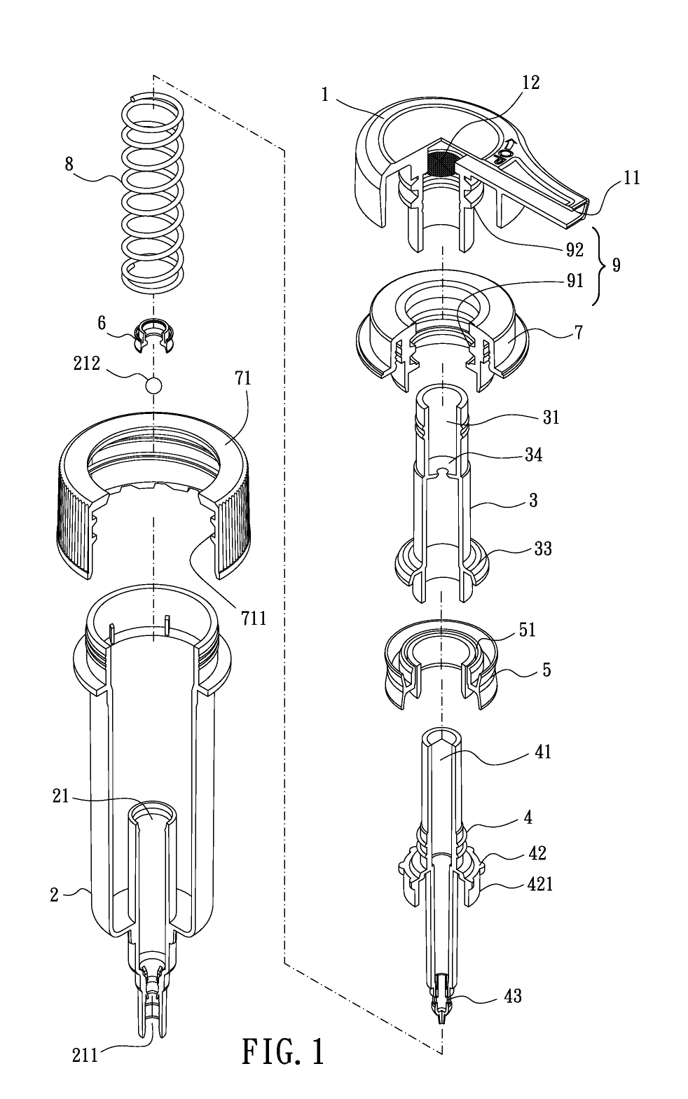

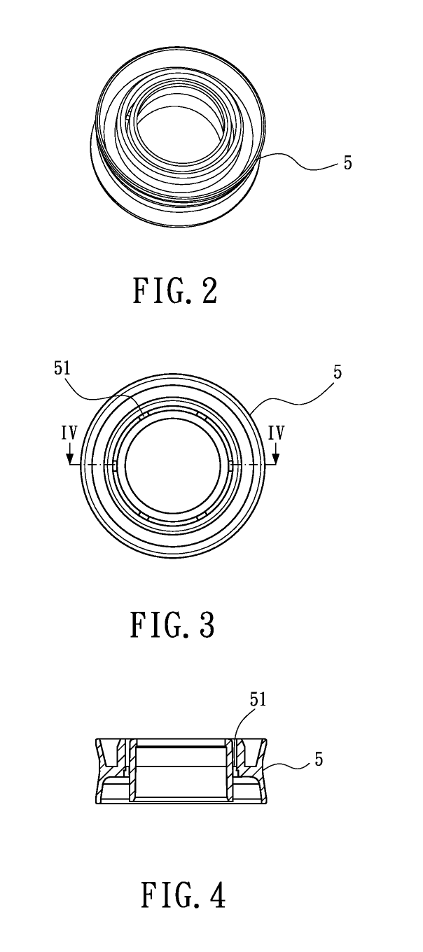

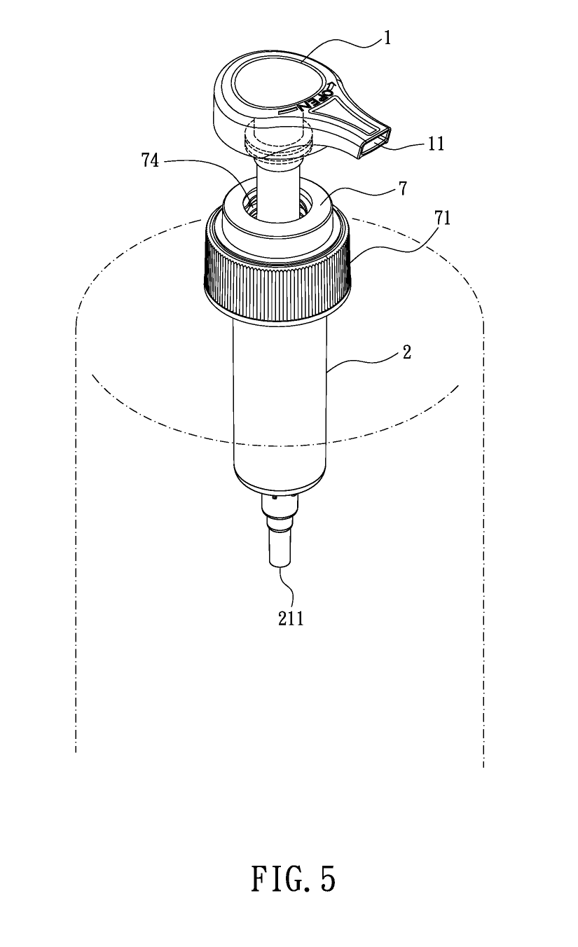

Referring to the drawings and initially to FIGS. 1-7, a foam dispensing device in accordance with a preferred embodiment of the present invention comprises an outer tube (2) axially connecting with a liquid container (not numbered), which may be a shampoo bottle, a lotion container, etc. The outer tube (2) has a tubular member (21) axially disposed therein and located at a bottom end thereof. An bottom end of the tubular member (21) extends from the bottom end of the outer tube (2) and is received in the liquid container. The tubular member (21) has a first inlet (211) defined in the bottom end thereof, such that liquid in the liquid container is guided into the tubular member (21) from the first inlet (211). A steel ball (212) is movably received in the tubular member (21) and located close to the first inlet (21). The steel ball (212) selectively seals the first inlet (211) to prevent a backflow of liquid in the tubular member (21). The outer tube (2) has a ventilating hole (22) laterally defined therein and extending therethrough for selectively communicating the outer tube (2) with the liquid container.

A lower tube (4) is axially and movably received in the outer tube (2). The lower tube (4) has a bottom end slidably received in a top end of the tubular member (21). The lower tube (4) has a guide chamber (41) defined therein. The bottom end of the lower tube (4) has a second inlet (43) laterally defined therein and located inside the tubular member (21) for selectively communicating the tubular member (21) with the guide chamber (41). A liquid piston (6) movably sleeves on the bottom end of the lower tube (4) for selectively sealing the second inlet (43). The lower tube (4) has a lower flange (42) annularly formed on an outer periphery thereof. The lower flange (42) has a restraining portion (421) annularly formed on an edge thereof and extending downwardly therefrom.

A spring (8) is a coil spring and axially received in the outer tube (2). The spring (8) is compressibly wound around the outer periphery of the lower tube (4) and an outer periphery of the tubular member (21) for providing a resilient force to the lower tube (4). The spring (8) has one end abutting against an interior bottom surface of the outer tube (2). The other end of the spring (8) abuts against a bottom of the lower flange (42) of the lower tube (4) and is restrained by the restraining portion (421) of the lower tube (4).

An upper tube (3) is partially and axially received in the outer tube (2). The upper tube (3) has a bottom end movably sleeving on a top end of the lower tube (4) and located above the lower flange (42) for simultaneously and axially moving with the lower tube (4) relative to the outer tube (2). The upper tube (3) has an upper flange (33) annularly formed on an outer periphery thereof. The upper tube (3) has an inward flange (34) annularly formed on an inner periphery thereof and downwardly inclined toward an axis of the outer tube (2). The top end of the lower tube (4) abuts against a bottom of the inward flange (34). The upper tube (3) has a mixing chamber (31) defined therein and located upon the inward flange (34). The mixing chamber (31) communicates with the guide chamber (41) of the lower tube (4). An air gap (32) is defined between an inner periphery of the bottom end of the upper tube (3) and an outer periphery of the top end of the lower tube (4). The air gap (32) extends between the upper tube (3) and the lower tube (4) to form a channel (not numbered) annularly located between the bottom end of the upper tube (3) and a top of the lower flange (42) for selectively communicating the outer tube (2) with the mixing chamber (31) and the guide chamber (41). Air in the outer tube (2) is able to flow along the inclined inward flange (34) via the air gap (32) and flow into the mixing chamber (31). Liquid in the guide chamber (41) flows upwardly to mix with air which is guided along the inward flange (34) for generating foam, such that foam generated by a mixture of air and liquid runs upwardly into the mixing chamber (31).

An air piston (5) is movably received in the outer tube (2) and sleeves on the upper tube (3). The air piston (5) is located between the upper flange (33) and the lower flange (42) for selectively sealing the air gap (32) and the ventilating hole (22) of the outer tube (2). The air piston (5) has at least one air hole (51) axially defined therein for guiding air into the outer tube (2).

A connecting cap (7) is mounted on a top end of the outer tube (2) and sleeves on the upper tube (3). The connecting cap (7) is located on a top of the liquid container. A ventilating space (74) is defined between the outer periphery of the upper tube (3) and an inner periphery of the connecting cap (7), such that air is able to flow into the outer tube (2) via the ventilating space (74). A container cap (71) sleeves on the connecting cap (7). The container cap (71) has a third threaded portion (711) annularly formed on an inner periphery thereof for being threadedly mounted on the top of the liquid container.

A dispensing head (1) is connected with a top end of the upper tube (3) for axially moving with the upper tube (3) and the lower tube (4) relative to the outer tube (2). The dispensing head (1) has a nozzle (11) formed thereon and communicating with the mixing chamber (31) of the upper tube (3). The dispensing head (1) has a grid member (12) disposed therein and located between the mixing chamber (31) and the nozzle (11). The grid member (12) has a plurality of tiny apertures (not shown) for enhancing foaming. A connecting structure (9) is formed between the connecting cap (7) and the dispensing head (1). The connecting structure (9) has a first threaded portion (91) annularly formed on the inner periphery of the connecting cap (7) and a second threaded portion (92) annularly formed on a bottom of the dispensing head (1), such that the first threaded portion (91) correspondingly engages with the second threaded portion (92).

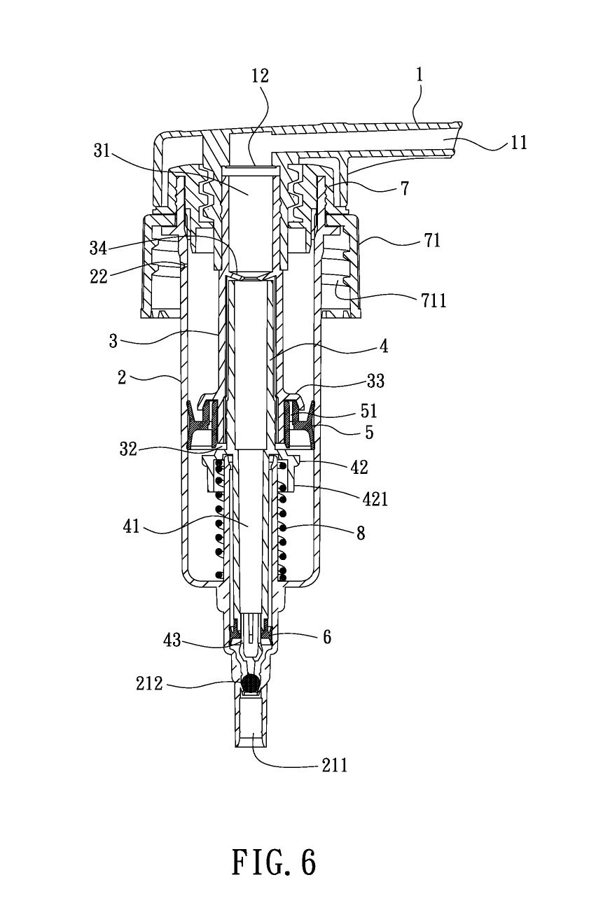

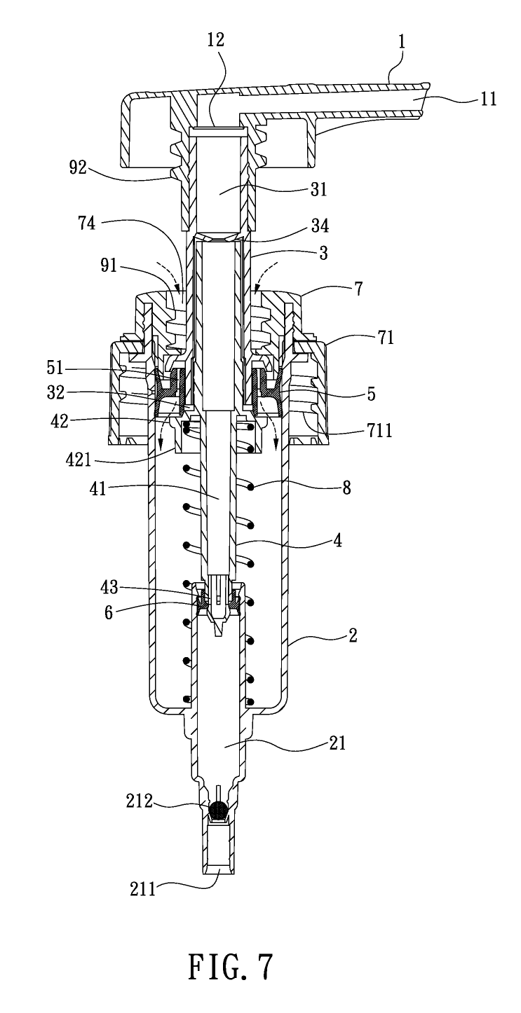

The operation of the foam dispensing device in accordance with the present invention will be described in detailed below. As shown in FIGS. 6-7, when the dispensing head (1) is pressed downwardly and threaded with the connecting cap (7), the dispensing head (1) seals the ventilating space (74). The upper tube (3) and the lower tube (4) are simultaneously moved downwardly. The spring (8) is compressed by the lower flange (42) of the lower tube (4). The foam dispensing device is in a storage position. When the dispensing head (1) is released from the connecting cap (7), the spring (8) has the resilient force to press the lower tube (4) upwardly. The upper tube (3) and the dispensing head (1) are simultaneously moved upwardly. The dispensing head (1) unseals the ventilating space (74), such that air is guided into the at least one air hole (51) to flow into the outer tube (2) via the ventilating space (74). The foam dispensing device is in an operation position.

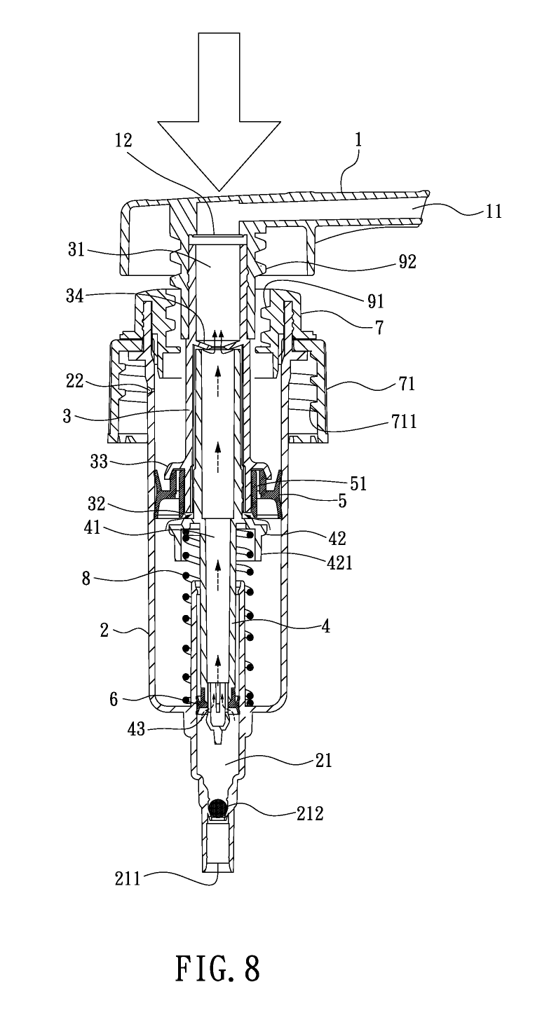

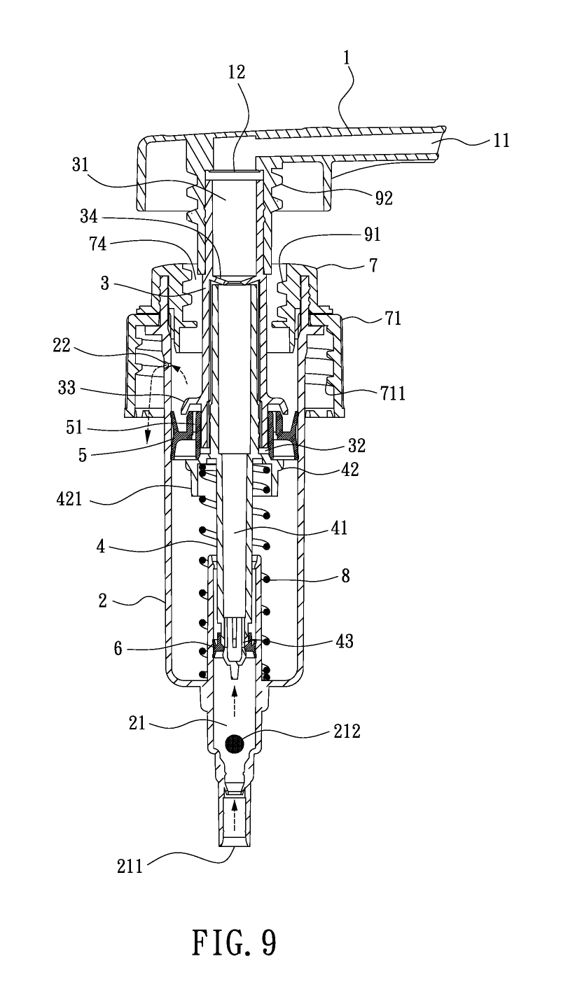

As shown in FIGS. 8-9, when the foam dispensing device is in the operation position and the dispensing head (1) is pressed downwardly by a user, the upper and lower tubes (3, 4) are simultaneously moved downwardly with the dispensing head (1). The upper flange (33) of the upper tube (3) is moved to push the air piston (5) downwardly and seals the at least one air hole (51) of the air piston (5), such that the air piston (5) unseals the air gap (32) and the ventilating hole (22). Air is able to flow into the liquid container from the outer tube (2) via the ventilating hole (22) for preventing the liquid container from contracting. Air in the outer tube (2) is forced to flow into the mixing chamber (31) of the upper tube (3) via the air gap (32). Simultaneously, the spring (8) is compressed by the lower flange (42) and the liquid piston (6) moves to unseal the second inlet (43) by an axial movement of the lower tube (4). Liquid in the tubular member (21) is forced to flow into the guide chamber (41) of the lower tube (4) via the second inlet (43) and mix with air for forming foam. Foam is sequentially guided into the mixing chamber (31) of the upper tube (3). Foam in the mixing chamber (31) is guided to pass through the grid member (12) to enhance foaming, and is discharged from the nozzle (11) of the dispensing head (1).

When the user releases the dispensing head (1), the spring (8) provides the resilient force for pressing the lower flange (42) of the lower tube (4) upwardly. The liquid piston (6) seals the second inlet (43) and the steel ball (212) unseals the first inlet (211) by the axial movement of the lower tube (4). Liquid in the liquid container is guided into the tubular member (21) via the first inlet (211). The upper tube (3) and the dispensing head (1) are simultaneously moved upwardly. The air piston (5) is pushed upwardly by the lower flange (42) of the lower tube (4), such that the air piston (5) seals the air gap (32) and the ventilating hole (22). The upper flange (33) of the upper tube (3) moves upwardly and unseals the at least one air hole (51).

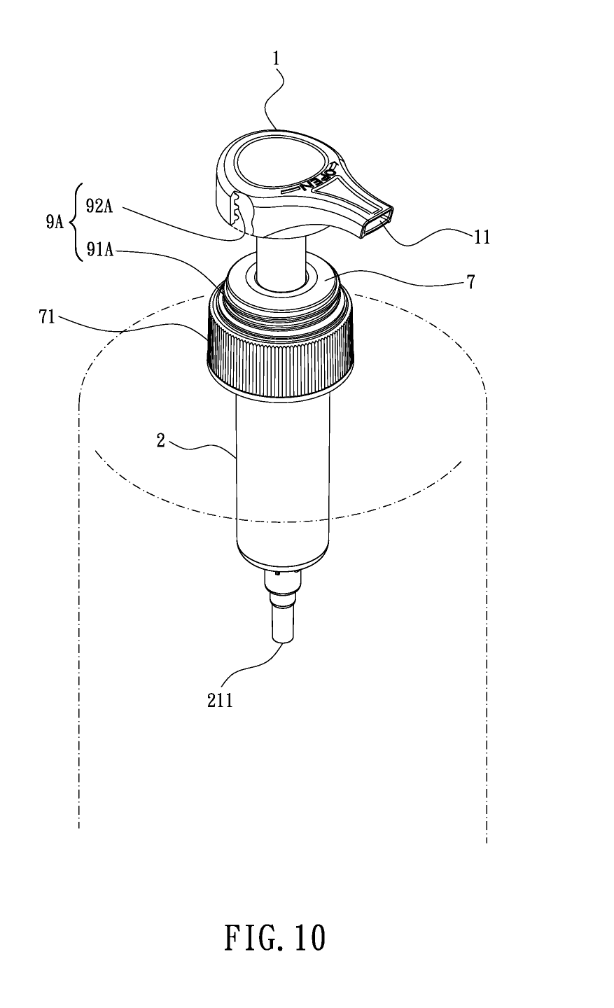

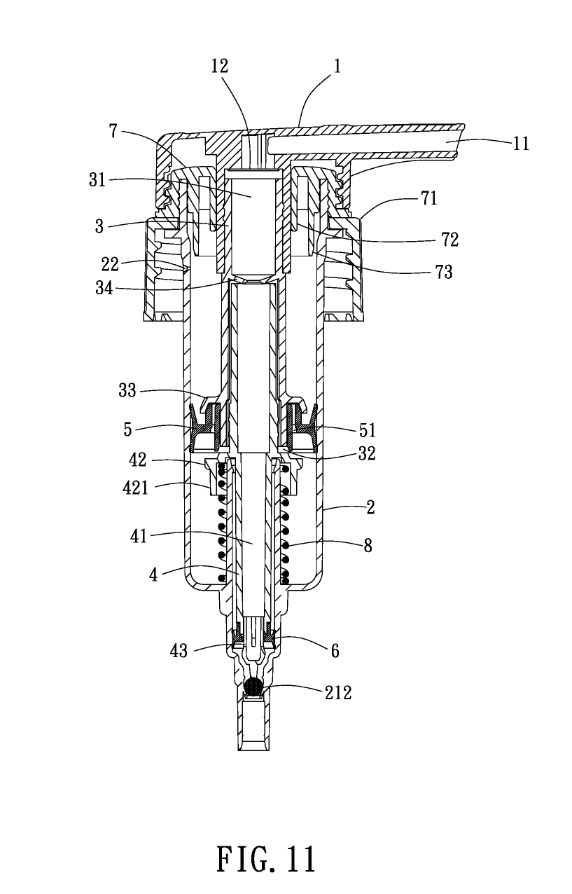

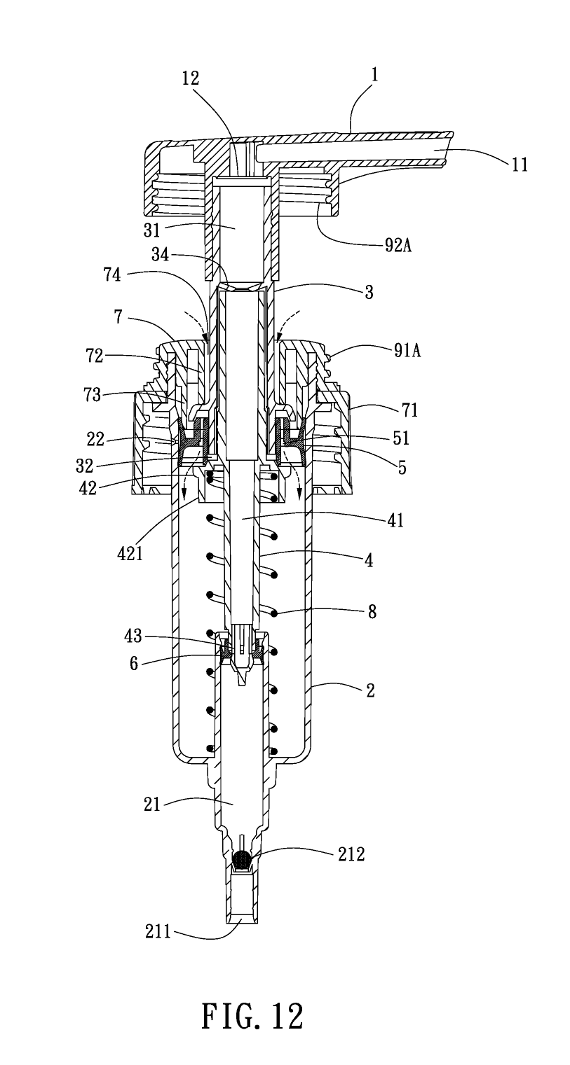

With reference to FIGS. 10-12, that shows a second embodiment of the foam dispensing device in accordance with the present invention. The elements and effects of the second embodiment which are the same with the preferred embodiment are not described, only the differences are described. In this embodiment, a connecting structure (9A) is formed between the connecting cap (7) and the dispensing head (1). the connecting structure (9A) has a first threaded portion (91A) annularly formed on an outer periphery of the connecting cap (7) and a second threaded portion (92A) annularly formed on the bottom of the dispensing head (1), such that the first threaded portion (91A) correspondingly and threadedly engages with the second threaded portion (92A). The connecting cap (7) has a first abutting portion (72) annularly formed thereon and extending downwardly therefrom. The first abutting portion (72) is received in the outer tube (2) and correspondingly abutting against a top of the upper flange (33) of the upper tube (3) for restricting an axial movement of the upper tube (3). The connecting cap (7) has a second abutting portion (73) annularly formed thereon and extending downwardly therefrom. The second abutting portion (73) is received in the outer tube (2) and correspondingly abutting against the top of the air piston (5) for restricting an axial movement of the air piston (5).

Although the invention has been explained in relation to its preferred embodiment, it is to be understood that many other possible modifications and variations can be made without departing from the spirit and scope of the invention as hereinafter claimed.

What is claimed is:

1. A foam dispensing device comprising:
an outer tube adapted to axially connect with a liquid container, the outer tube having a tubular member axially disposed therein and located at a bottom end thereof, the tubular member having a first inlet defined in a bottom end thereof and adapted to be received in the liquid container, such that liquid in the liquid container is guided into the tubular member from the first inlet, a steel ball movably received in the tubular member and located close to the first inlet for preventing a backflow of liquid in the tubular member;
a lower tube axially and movably received in the outer tube, the lower tube having a bottom end slidably received in a top end of the tubular member, the lower tube having a guide chamber defined therein, the bottom end of the lower tube having a second inlet laterally defined therein for selectively communicating the tubular member with the guide chamber, a liquid piston connected with the bottom end of the lower tube for selectively sealing the second inlet, the lower tube having a lower flange annularly formed on an outer periphery thereof;
a spring compressibly and axially received in the outer tube, the spring having two ends respectively abutting against the outer tube and the lower tube for providing a resilient force to the lower tube;
an upper tube axially and movably received in the outer tube, the upper tube having a bottom end sleeving on a top end of the lower tube for simultaneously and axially moving with the lower tube relative to the outer tube, the upper tube having a mixing chamber defined therein and communicating with the guide chamber of the lower tube, an air gap defined between an inner periphery of the bottom end of the upper tube and an outer periphery of the top end of the lower tube, the air gap extending between the upper tube and the lower tube to form a channel annularly located between the bottom end of the upper tube and a top of the lower flange for selectively communicating the outer tube with the mixing chamber and the guide chamber, the upper tube having an upper flange annularly formed on an outer periphery thereof;
an air piston movably received in the outer tube and sleeving on the upper tube, the air piston located between the upper flange and the lower flange for selectively sealing the air gap, the air piston having at least one air hole axially defined therein for guiding air into the outer tube; and
a dispensing head connected with a top end of the upper tube for axially moving with the upper tube and the lower tube relative to the outer tube, the dispensing head having a nozzle formed thereon and communicating with the mixing chamber of the upper tube;
whereby when the dispensing head is pressed downwardly by a user, the upper and lower tubes are simultaneously moved downwardly with the dispensing head, the upper flange moved to push the air piston downwardly and sealing the at least one air hole of the air piston, such that the air piston unseals the air gap, air in the outer tube forced to flow into the mixing chamber via the air gap, liquid in the tubular member flowing into the guide chamber of the lower tube via the second inlet and sequentially guided into the mixing chamber of the upper tube for mixing with air; when the user releases the dispensing head, the spring provides the resilient force to press the lower tube upwardly, and the upper tube and the dispensing head are simultaneously moved upwardly, the air piston pushed upwardly by the lower tube, such that the air piston seals the air gap and the upper flange unseals the at least one air hole.

2. The foam dispensing device as claimed in claim 1, wherein the liquid piston is received in the tubular member and movably sleeves on the bottom end of the lower tube, wherein when the dispensing head is pressed downwardly, the lower tube slides downwardly and the liquid piston unseals the second inlet, liquid in the tubular member forced to flow into the guide chamber of the lower tube via the second inlet; when the dispensing head is released, the lower tuber is moved upwardly by the resilient force of the spring, the liquid piston seals the second inlet.

3. The foam dispensing device as claimed in claim 1, wherein the dispensing head has a grid member disposed therein and located between the mixing chamber and the nozzle for enhancing foaming.

4. The foam dispensing device as claimed in claim 1, wherein the outer tube has a ventilating hole laterally defined therein and extending therethrough for selectively communicating the outer tube with the liquid container, the air piston selectively sealing the ventilating hole.

5. The foam dispensing device as claimed in claim 1 further comprising a connecting cap mounted on a top end of the outer tube and sleeving on the upper tube, the connecting cap adapted to be located on a top of the liquid container, a ventilating space defined between the outer periphery of the upper tube and an inner periphery of the connecting cap, such that air is able to flow into the outer tube via the ventilating space.

6. The foam dispensing device as claimed in claim 1, wherein the spring is compressibly wound around the outer periphery of the lower tube and an outer periphery of the tubular member, the two ends of the spring respectively abutting against the lower flange of the lower tube and an interior bottom surface of the outer tube.

7. The foam dispensing device as claimed in claim 5, wherein the connecting cap and the dispensing head has a connecting structure formed therebetween, the connecting structure having a first threaded portion annularly formed on the inner periphery of the connecting cap, the connecting structure having a second threaded portion annularly formed on a bottom of the dispensing head for correspondingly engaging with the first threaded portion of the connecting cap.

8. The foam dispensing device as claimed in claim 5, wherein the connecting cap and the dispensing head has a connecting structure formed therebetween, the connecting structure has a first threaded portion annularly formed on an outer periphery of the connecting cap, the connecting structure having a second threaded portion annularly formed on the bottom thereof for correspondingly and threadedly connecting with the first threaded portion.

9. The foam dispensing device as claimed in claim 5 further comprising a container cap sleeving on the connecting cap, the container cap having a third threaded portion annularly formed on an inner periphery thereof for adapting to be mounted on the top of the liquid container.

10. The foam dispensing device as claimed in claim 5, wherein the connecting cap has a first abutting portion annularly formed thereon and extending downwardly therefrom, the first abutting portion received in the outer tube and correspondingly abutting against a top of the upper flange of the upper tube for restricting an axial movement of the upper tube, the connecting cap having a second abutting portion annularly formed thereon and extending downwardly therefrom, the second abutting portion received in the outer tube and correspondingly abutting against a top of the air piston for restricting an axial movement of the air piston.

11. The foam dispensing device as claimed in claim 1, wherein the lower flange of the lower tube has a restraining portion annularly formed on an edge thereof and extending downwardly therefrom for restraining one end of the spring.
